(19) United States
(12) Patent Application Publication
(10) Pub. No.: US 2026/0135334 A1
(43) Pub. Date: May 14, 2026

(54) PLUGGABLE MODULE AND ELECTRONIC DEVICE

(71) Applicant: Wistron NeWeb Corporation, Hsinchu (TW)

(72) Inventors: Ting-Jeng LIU, Hsinchu (TW); Bo-Yen CHEN, Hsinchu (TW)

(21) Appl. No.: 19/218,994

(22) Filed: May 27, 2025

(30) Foreign Application Priority Data
Nov. 8, 2024 (TW) 113143028

(51) Int. Cl. H01R 13/633; H01R 24/52; H01R 31/06

(52) U.S. Cl. CPC H01R 13/6335; H01R 24/52; H01R 31/06

(57) ABSTRACT

A pluggable module is configured to be installed in an electronic device and has a plug-in direction and a pull-out direction. The plug-in direction and the pull-out direction are parallel and opposite to each other. The pluggable module includes an outer connector, an inner connector and a base. The outer connector is a coaxial connector and includes a plurality of outer terminals. The inner connector is disposed opposite to the outer connector along the pull-out direction and includes a plurality of inner terminals, which are communicatively connected to the outer terminals. The outer connector and the inner connector are accommodated in the base.

### RELATED APPLICATIONS

This application claims the benefit of priority to Taiwan Patent Application No. 113143028, filed on November 08, 2024. The entire content of the above identified application is incorporated herein by reference.

### BACKGROUND

### Technical Field

The present disclosure relates to a pluggable module and an electronic device, in particular to a pluggable module and an electronic device that include a coaxial connector.

### Description of Related Art

With the rapid advancement of technology, there is often a need for the coexistence and compatibility of new and old interfaces or devices. For example, with the advent of the internet era, the structure of home and public networks has become increasingly sophisticated and complex. Consumers’ demand for high-speed network devices has also gradually increased, resulting in an increase in the power of computing components and transmission modules in network communication products. Consequently, the specifications of network communication products must be continuously optimized and improved to meet these demands. Therefore, there is a need for interface adapters in network communication products to allow older devices to connect to increasingly updated network communication products.

Based on the above, in the current market for electronic devices and their connector modules and/or adapter modules, there is an urgent need to develop an electronic device and its connector module and/or adapter module that facilitate the adaptation between new and old interfaces to accommodate rapidly developing interface technologies.

### SUMMARY

According to one aspect of the present disclosure, a pluggable module is provided. The pluggable module is configured to be installed in an electronic device and has a plug-in direction and a pull-out direction. The plug-in direction and the pull-out direction are parallel and opposite to each other. The pluggable module includes an outer connector, an inner connector, and a base. The outer connector is a coaxial connector and includes a plurality of outer terminals. The inner connector is disposed opposite to the outer connector along the pull-out direction and includes a plurality of inner terminals, which are communicatively connected to the outer terminals. The outer connector and the inner connector are accommodated in the base.

According to another aspect of the present disclosure, an electronic device is provided and includes a pluggable module. The pluggable module has a plug-in direction and a pull-out direction for insertion into and removal from a device opening of the electronic device. The pluggable module includes an outer connector, an inner connector, and a base. The outer connector is a coaxial connector and includes a plurality of outer terminals. When the pluggable module is in a communication operation state, the outer connector is exposed on a device outer surface of the electronic device. The inner connector is disposed opposite to the outer connector along the pull-out direction and includes a plurality of inner terminals, which are communicatively connected to the outer terminals. The outer connector and the inner connector are accommodated in the base.

### BRIEF DESCRIPTION OF THE DRAWINGS

The present disclosure can be more fully understood by reading the following detailed description of the embodiment, with reference made to the accompanying drawings as follows:

FIG. 1A is a three-dimensional view of a pluggable module according to a first embodiment of the present disclosure.

FIG. 1B is an exploded view of the pluggable module shown in FIG. 1A.

FIG. 1C is another three-dimensional view of the pluggable module shown in FIG. 1A.

FIG. 1D is a sectional view along line 1D-1D of FIG. 1A.

FIG. 2A is a three-dimensional view of an electronic device according to a second embodiment of the present disclosure.

FIG. 2B is an exploded view of the electronic device shown in FIG. 2A.

FIG. 2C is a schematic diagram of the pluggable module of the electronic device shown in FIG. 2A in a communication operation state.

FIG. 2D is a schematic diagram of the pluggable module of the electronic device shown in FIG. 2A during a pull-out process.

### DETAILED DESCRIPTION

The present disclosure is more particularly described in the following embodiments that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

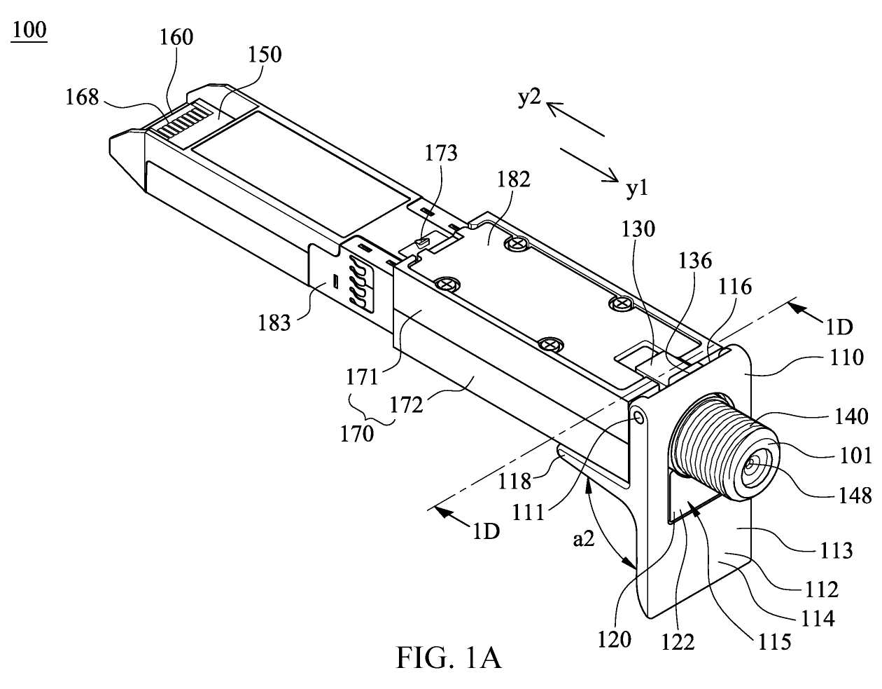

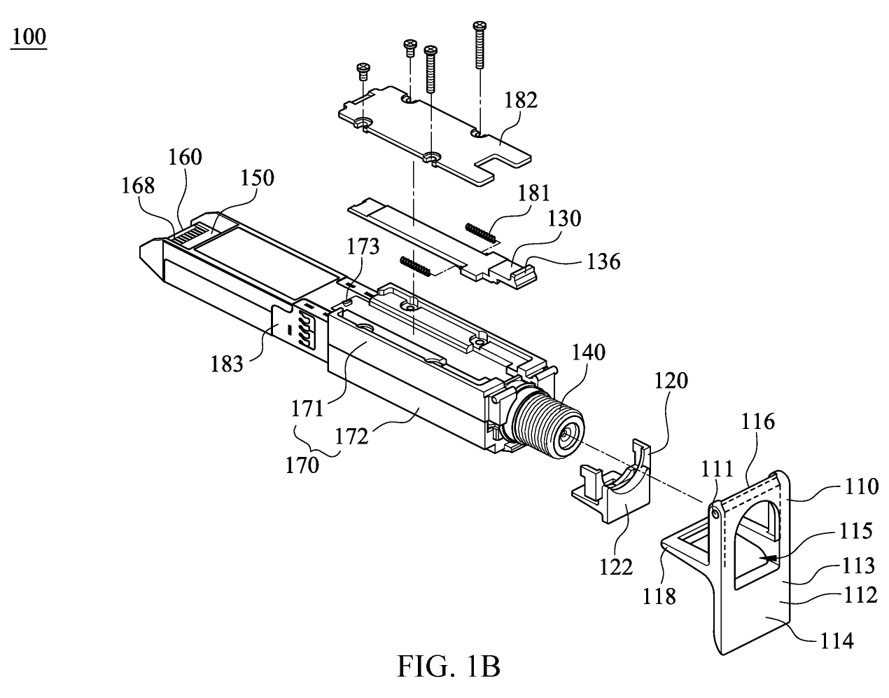

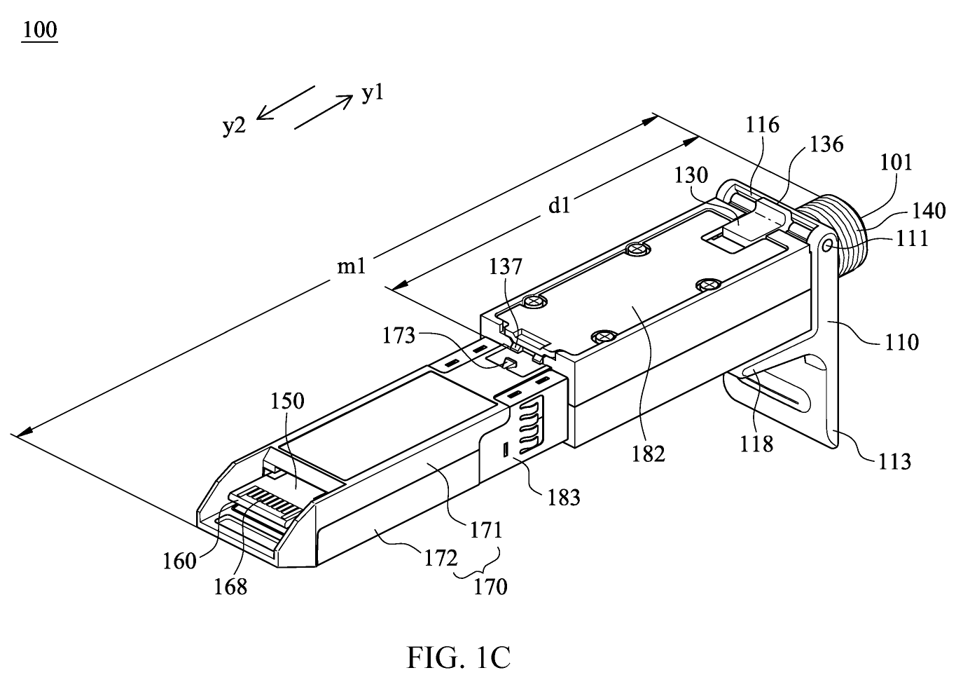

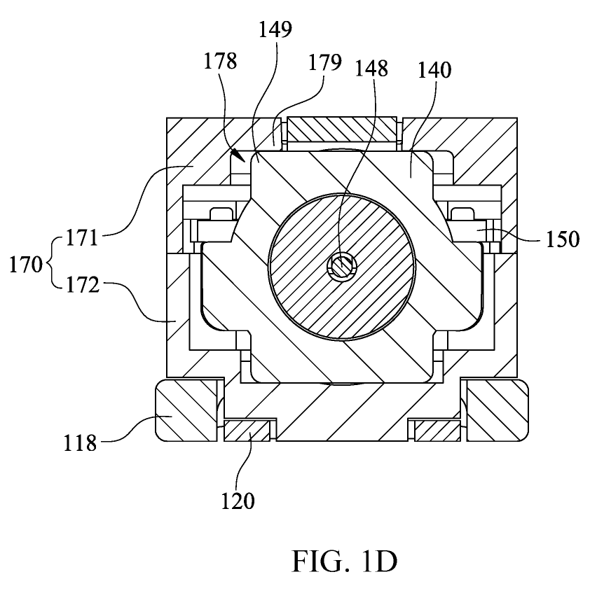

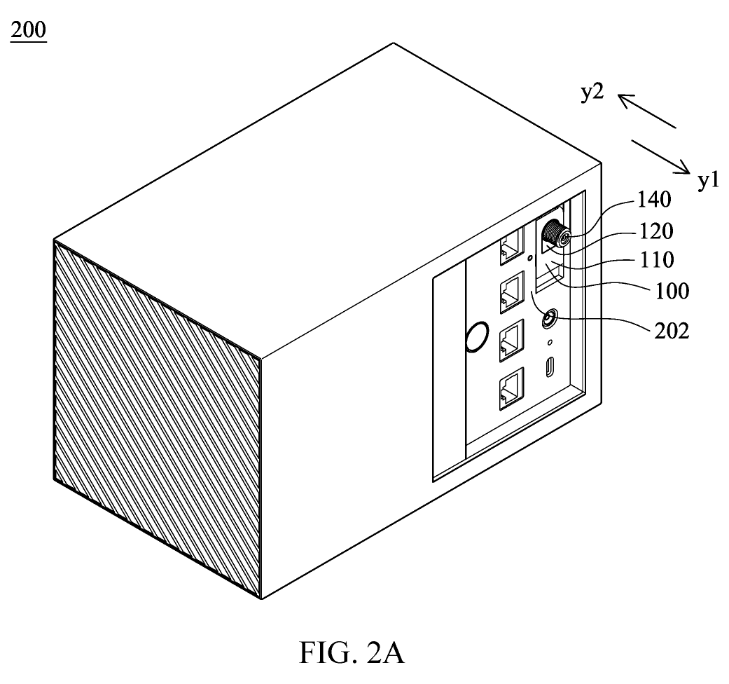

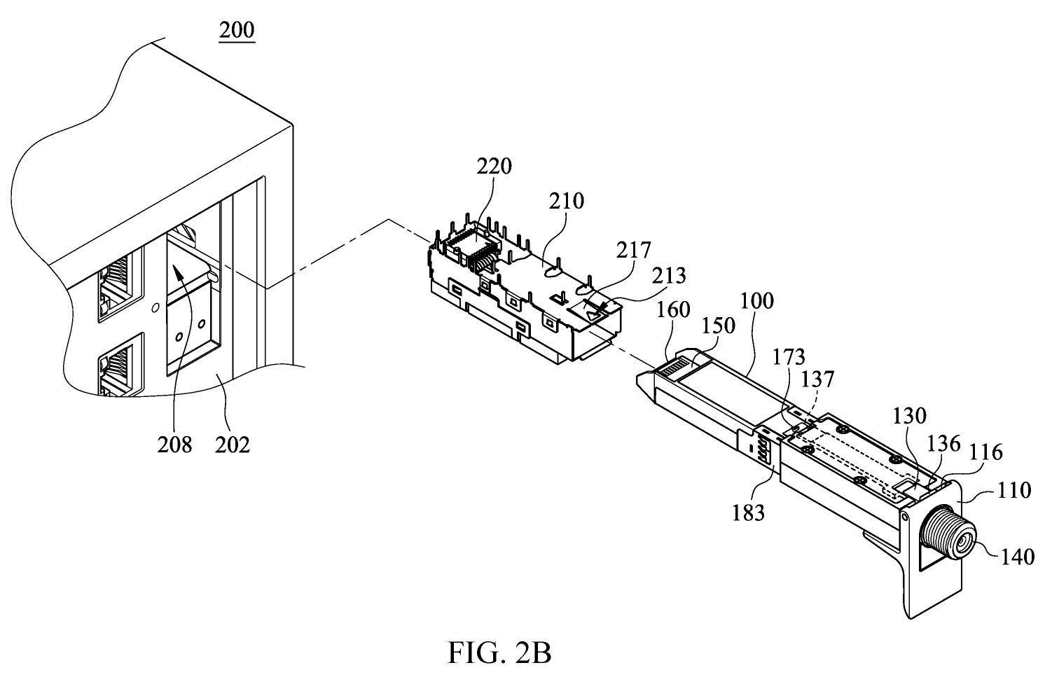

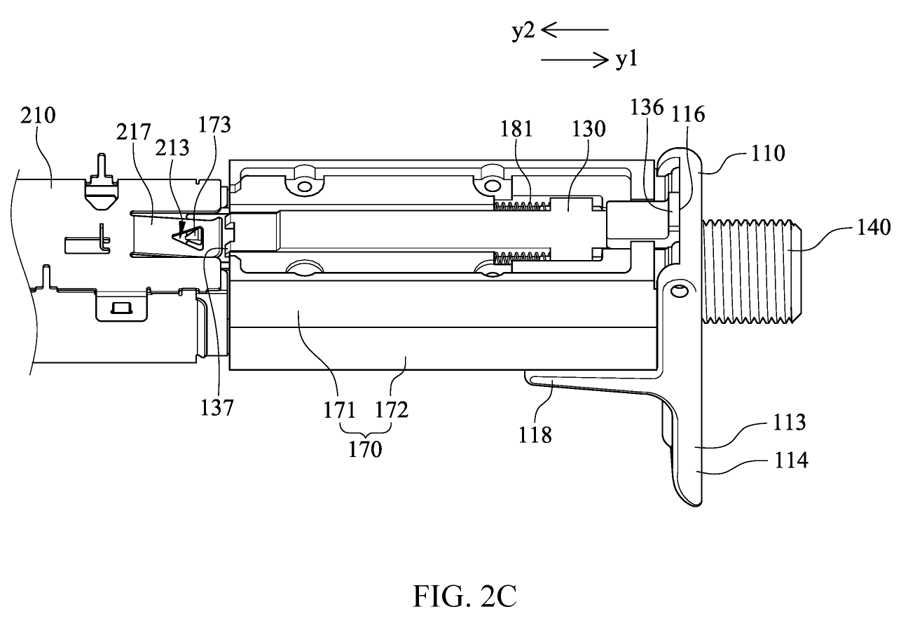

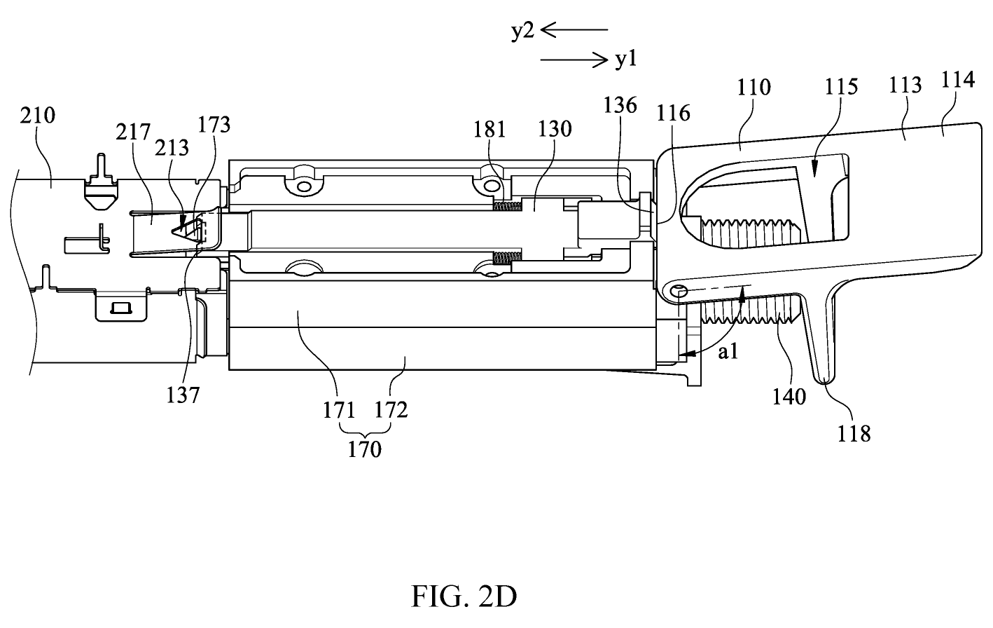

FIG. 1A is a three-dimensional view of a pluggable module 100 according to a first embodiment of the present disclosure. FIG. 1B is an exploded view of the pluggable module 100 shown in FIG. 1A. FIG. 1C is another three-dimensional view of the pluggable module 100 shown in FIG. 1A. Please refer to FIGS. 1A to 1C, the pluggable module 100 is configured to be installed in an electronic device (for example, an electronic device 200 in a second embodiment shown in FIG. 2A) and has a plug-in direction y2 and a pull-out direction y1. The plug-in direction y2 and the pull-out direction y1 are parallel and opposite to each other. The pluggable module 100 includes an outer connector 140, an inner connector 160, and a base 170. The outer connector 140 is a coaxial connector and includes a plurality of outer terminals 148. The inner connector 160 is disposed opposite to the outer connector 140 along the pull-out direction y1 and includes a plurality of inner terminals 168, which are communicatively connected to the outer terminals 148. The outer connector 140 and the inner connector 160 are accommodated in the base 170. Therefore, the pluggable module 100 facilitates adaptation between a coaxial connector and another communication interface.

In detail, the pluggable module 100 may be a Small Form-Factor Pluggable (SFP) module, and the outer connector 140 may be an F-type connector. As a result, high-speed data transmission commonly uses fiber optics as a medium, and connectors are gradually shifting from traditional coaxial cable F-type ports (coaxial cable F port) to Ethernet ports. However, a certain percentage of existing consumers are unwilling to update network communication accessories every year. In response, a MoCA (Multimedia over Coax Alliance) adapter/converter including the pluggable module 100 disclosed herein has the advantage of easy plug-in and removal, which increases user adoption and facilitates connecting older devices to increasingly modern network communication products.

The pluggable module 100 may further include a pulling component 110, which is positioned adjacent to the outer connector 140. The pulling component 110 has a pivot 111 and is pivotally connected to the base 170. The pivot 111 is perpendicular to the pull-out direction y1. The pulling component 110 is configured to allow a user to apply force to move the pluggable module 100 along the pull-out direction y1. Thus, by applying force to the pulling component 110, which is pivotally connected to the base 170 of the pluggable module 100, the removal process is made smoother.

The pulling component 110 may include a first pulling portion 113 and a second pulling portion 118. When the pluggable module 100 is in a communication operation state (i.e., when the pluggable module 100 is installed in an electronic device, as shown in FIGS. 1A and 1C), the first pulling portion 113 is perpendicular to the pull-out direction y1. The angle a2 formed between the first pulling portion 113 and the second pulling portion 118 may range from 45 degrees to 100 degrees. This configuration ensures both the stability of the pluggable module 100 during communication operation and the reliability of the pull-out process. Additionally, the angle a2 may range from 80 degrees to 100 degrees. In the first embodiment, the angle a2 is approximately 90 degrees.

The second pulling portion 118 may be positioned closer to the inner connector 160 than the first pulling portion 113 thereto. This configuration further enhances the aesthetic appearance of the design.

The first pulling portion 113 may include a pulling zone 114, which is configured to allow the user to apply force to move the pluggable module 100 along the pull-out direction y1. The first pulling portion 113 may include an avoidance opening 115. When the pluggable module 100 is in the communication operation state, the avoidance opening 115 allows the outer connector 140 to pass through. Accordingly, the second pulling portion 118 extends from the junction of the pulling zone 114 and the frame of the avoidance opening 115 of the first pulling portion 113, forming the angle a2. This configuration facilitates pulling convenience within a limited volume.

The pluggable module 100 may further include a front jaw component 120, which is physically connected to the base 170 and made of plastic material. When the pluggable module 100 is in the communication operation state, the front jaw component 120 fills a gap in the avoidance opening 115. Accordingly, the plastic front jaw component 120 is designed to seal the cavity of the electronic device where the pluggable module 100 is installed, ensuring that users are not burned due to the high power of the pluggable module 100 during the removal process. Furthermore, the appropriate design of the front jaw component 120 helps reduce electromagnetic interference (EMI) and meets industrial design (ID) and thermal management requirements for customers.

The first pulling portion 113 may include a pulling outer surface 112, and the front jaw component 120 may include a front jaw outer surface 122. When the pluggable module 100 is in the communication operation state, the front jaw outer surface 122 is aligned with the pulling outer surface 112. Accordingly, this enhances the aesthetic appearance of the electronic device where the pluggable module 100 is installed.

When the pluggable module 100 is in the communication operation state, an edge of the front jaw outer surface 122 (e.g., the upper edge of the front jaw outer surface 122 in FIG. 1A) may correspond to an edge of the outer connector 140, and another edge of the front jaw outer surface 122 (e.g., the lower and left edges of the front jaw outer surface 122 in FIG. 1A) may correspond to an edge of the avoidance opening 115. Accordingly, this further enhances the sealing capability of the pluggable module 100 and maintains its ease of removal.

The base 170 may include a first base member 171 and a second base member 172, both of which extend along the pull-out direction y1 and are disposed opposite to each other. The first base member 171 and the second base member 172 are both made of zinc die-casting. One end of the first base member 171 facing the plug-in direction y2 has a chamfered and tapered structure, serving as an insertion guide to assist in smoothly blind-mating the elongated pluggable module 100 into the deep interior of the electronic device.

The pulling component 110 may include a pushing zone 116. The pluggable module 100 may further include a latch component 130 and a cover component 182. The latch component 130 is physically connected to and housed within a recess of the first base member 171 of the base 170, facing away from the second base member 172, and is covered by the cover component 182. The latch component 130 includes a trigger zone 136 and an unlocking zone 137, with the unlocking zone 137 positioned closer to the inner connector 160 than the trigger zone 136 thereto, as shown in FIG. 1C. During a pull-out process of the pluggable module 100 along the pull-out direction y1, the pushing zone 116 pushes the trigger zone 136, causing the latch component 130 to move relative to the base 170 along the plug-in direction y2, and the unlocking zone 137 releases the pluggable module 100 from the electronic device. Accordingly, the pulling component 110 may specifically be a lever paddle, which cooperates with the latch component 130 and two elastic components 181, enabling the pluggable module 100 to be released from the electronic device via the unlocking zone 137. For example, as shown in FIG. 2D, when the unlocking zone 137 moves relative to the base 170 along the plug-in direction y2, the unlocking zone 137 contacts and pushes the elastic zone 217 of the fixing frame 210 in the electronic device 200, causing deformation. As a result, the second latching portion 173 of the first base member 171 of the pluggable module 100 disengages from the first latching portion 213 of the fixing frame 210 of the electronic device 200, allowing the pluggable module 100 to be pulled out from the electronic device 200. Furthermore, the elastic component 181 can also create a removal force threshold, preventing the pluggable module 100, when installed in the electronic device 200 and in the communication operation state, from loosening due to vibrations of the electronic device 200, which could cause signal disconnection. Additionally, the elastic component 181 provides a tactile response during removal, enhancing user experience.

When the pulling component 110 rotates about the pivot 111 at a pivoting angle a1 greater than 85 degrees, the pushing zone 116 can push the trigger zone 136, thereby releasing the pluggable module 100 from the electronic device. Accordingly, a larger pivoting angle a1 helps prevent the pluggable module 100 from being unintentionally pulled out due to vibrations or accidental movements during communication operation. In the first embodiment, the pivoting angle a1 is 90.2 degrees (as shown in FIG. 2D), but is not limited thereto.

Please refer to FIG. 1C, when the pluggable module 100 is in the communication operation state, the distance d1 between the unlocking zone 137 and an outer endpoint 101 of the pluggable module 100 along the pull-out direction y1 and the length m1 of the pluggable module 100 along the pull-out direction y1 may satisfy the following condition: 0.3 ≤ d1/m1 ≤ 0.7. Accordingly, this particularly helps ensure the stability of the elongated pluggable module 100 during the plug-in and pull-out processes. In the first embodiment, the distance d1 is 52.1 mm, and the length m1 is 99.2 mm, yielding a ratio d1/m1 of 0.53, but the disclosure is not limited thereto.

Please refer to FIGS. 1A to 1C, the pluggable module 100 may further include a circuit board 150, which is physically connected to and communicatively connected to the outer connector 140. Specifically, the circuit board 150 is housed within the cavity formed by the first base member 171 and the second base member 172. One end of the circuit board 150 in the pull-out direction y1 is physically connected to the outer connector 140, and the other end in the plug-in direction y2 forms the inner connector 160 and its inner terminals 168 in a Golden Fingers configuration. In the present disclosure, the inner connector may also be a connector soldered onto the circuit board 150, but the present disclosure is not limited thereto.

FIG. 1D is a sectional view along line 1D-1D of FIG. 1A. Please refer to FIG. 1D, the outer connector 140 may include a plurality of anti-rotation portions 149, which are disposed on an outer surface of the outer connector 140 and arranged in a polygonal shape. The base 170 may include a base opening 178 and a plurality of stopper portions 179. The outer connector 140 is physically connected to the circuit board 150 through the base opening 178, and the stopper portions 179 are respectively adjacent to the anti-rotation portions 149. During the pull-out process of the pluggable module 100 along the pull-out direction y1, the stopper portions 179 are configured to contact and block the anti-rotation portions 149 when the outer connector 140 rotates/twists clockwise or counterclockwise beyond a rotational threshold, thereby preventing further rotation of the outer connector 140. Accordingly, since small coaxial connectors (such as F-type connectors) have a limited soldering area on the circuit board 150, the pluggable module 100 disclosed herein can effectively prevent excessive twisting of the outer connector 140, which could otherwise damage its mechanical structure and communication performance.

The number of the anti-rotation portions 149 may be four, and the four anti-rotation portions 149 correspond to the four corners of a rectangle. Accordingly, the pluggable module 100 disclosed herein is specifically designed with the anti-rotation portions 149 and stopper portions 179 to match the coaxial mechanical properties of the outer connector 140. The first base member 171 and the second base member 172 of the base 170 each have two stopper portions 179, which respectively correspond to the four anti-rotation portions 149 at the square corners of the outer connector 140. This effectively transfers the torque applied to the outer connector 140 to the structurally strong zinc die-cast base 170, thereby reducing the likelihood of solder cracking between the outer connector 140 and the circuit board 150 due to excessive insertion or removal torque.

FIG. 2A is a three-dimensional view of an electronic device 200 according to a second embodiment of the present disclosure. FIG. 2B is an exploded view of the electronic device 200 shown in FIG. 2A, and it should be noted that in FIG. 2B, the fixing frame 210 and the adapter 220 are components that are fixed inside the electronic device 200 and engage with the pluggable module 100. Please refer to FIGS. 2A and 2B, the electronic device 200 includes the pluggable module 100 of the first embodiment. The pluggable module 100 has the plug-in direction y2 and the pull-out direction y1, allowing it to be inserted into and removed from a device opening 208 of the electronic device 200. The pluggable module 100 includes the outer connector 140, the inner connector 160, and the base 170. The outer connector 140 is the coaxial connector and includes the plurality of outer terminals 148. When the pluggable module 100 is in the communication operation state, the outer connector 140 is exposed on a device outer surface 202 of the electronic device 200. The inner connector 160 is disposed opposite to the outer connector 140 along the pull-out direction y1 and includes the plurality of inner terminals 168, which are communicatively connected to the outer terminals 148. The outer connector 140 and the inner connector 160 are accommodated in the base 170. Accordingly, the pluggable module 100 facilitates adaptation between a coaxial connector and another communication interface. Furthermore, by upgrading to and maintaining compatibility with newer interfaces, the need for a complete replacement with newer interface devices is avoided. Specifically, the electronic device 200 is a router and further includes an Ethernet connector disposed on the device outer surface 202. The outer connector 140 of the pluggable module 100 is an F-type connector. The outer connector 140 is communicatively connected in sequence to the inner connector 160, the adapter 220, and the Ethernet connector, enabling the electronic device 200 to provide MoCA (Multimedia over Coax Alliance) connectivity between old and new network communication interfaces.

FIG. 2C is a schematic diagram of the pluggable module 100 in the electronic device 200 shown in FIG. 2A during the communication operation state. In FIG. 2C, the pluggable module 100 is illustrated with the cover component 182 removed to clearly depict its communication operation state. Please refer to FIGS. 2B and 2C, the electronic device 200 may further include a fixing frame 210, which is disposed inside the electronic device 200 and includes a first latching portion 213, while the first base member 171 of the base 170 may include a second latching portion 173. When the pluggable module 100 is in the communication operation state, the first latching portion 213 and the second latching portion 173 engage with each other to fix/secure the pluggable module 100 in the fixing frame 210. Accordingly, when the pluggable module 100 is in the communication operation state, the fixing frame 210, which is specifically a metal cage, further achieves fixation by being pressed against the grounding spring 183 on the outer surface of the base 170. This helps prevent the pluggable module 100 from loosening or experiencing signal disconnection due to vibrations of the electronic device 200.

FIG. 2D is a schematic diagram of the pluggable module 100 in the electronic device 200 shown in FIG. 2A during the pull-out process. In FIG. 2D, the pluggable module 100 is illustrated with the cover component 182 removed to clearly depict the pull-out process. Please refer to FIGS. 2B to 2D, the pulling component 110 is configured to allow the user to apply force to pull the pluggable module 100 out of the device opening 208 of the electronic device 200 along the pull-out direction y1. Accordingly, by applying force to the pulling component 110, which is pivotally connected to the pluggable module 100, the pull-out process is made smoother.

The fixing frame 210 may further include an elastic zone 217, with the first latching portion 213 located at the elastic zone 217 as an opening, and the second latching portion 173 being a triangular protrusion. The pluggable module 100 may further include the unlocking zone 137. During the pull-out process of the pluggable module 100 along the pull-out direction y1, the unlocking zone 137 contacts and deforms the elastic zone 217, thereby disengaging the second latching portion 173 from the first latching portion 213. Accordingly, as shown in FIG. 2C, the first latching portion 213 and the second latching portion 173 engage with each other in the communication operation state, ensuring that horizontal pulling alone does not cause the pluggable module 100 to detach from the electronic device 200. However, when removing the pluggable module 100, as shown in FIG. 2D, the pulling component 110, the elastic component 181, and the latch component 130 together form a pull-release mechanism. When the pulling component 110 rotates, it pushes the latch component 130 horizontally, compressing the elastic component 181 and lifting the elastic zone 217 of the fixing frame 210 in the electronic device 200. This action disengages the first latching portion 213 from the second latching portion 173, allowing the pluggable module 100 to detach from the fixing frame 210 of the electronic device 200.

For further details regarding the pluggable module 100 in the electronic device 200, please refer to the descriptions of the first embodiment above, which will not be repeated herein.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A pluggable module configured to be installed in an electronic device and having a plug-in direction and a pull-out direction, wherein the plug-in direction and the pull-out direction are parallel and opposite to each other, and the pluggable module comprises:
an outer connector, which is a coaxial connector and comprises a plurality of outer terminals;
an inner connector disposed opposite to the outer connector along the pull-out direction and comprising a plurality of inner terminals communicatively connected to the outer terminals; and
a base, wherein the outer connector and the inner connector are accommodated in the base.

2. The pluggable module of claim 1, further comprising:
a pulling component disposed adjacent to the outer connector, wherein the pulling component has a pivot and is pivotally connected to the base, the pivot is perpendicular to the pull-out direction, and the pulling component is configured to allow a user to apply force to move the pluggable module along the pull-out direction.

3. The pluggable module of claim 2, wherein the pulling component comprises:
a first pulling portion; and
a second pulling portion;
wherein when the pluggable module is in a communication operation state, the first pulling portion is perpendicular to the pull-out direction, and an angle formed between the first pulling portion and the second pulling portion ranges from 45 degrees to 100 degrees.

4. The pluggable module of claim 3, wherein the second pulling portion is positioned closer to the inner connector than the first pulling portion thereto.

5. The pluggable module of claim 3, wherein the angle ranges from 80 degrees to 100 degrees.

6. The pluggable module of claim 3, wherein the first pulling portion comprises:
an avoidance opening;
wherein when the pluggable module is in a communication operation state, the avoidance opening allows the outer connector to pass through.

7. The pluggable module of claim 6, further comprising:
a front jaw component physically connected to the base and made of plastic material;
wherein when the pluggable module is in the communication operation state, the front jaw component fills a gap in the avoidance opening.

8. The pluggable module of claim 7, wherein the first pulling portion comprises a pulling outer surface, and the front jaw component comprises a front jaw outer surface;
wherein when the pluggable module is in the communication operation state, the front jaw outer surface is aligned with the pulling outer surface.

9. The pluggable module of claim 8, wherein when the pluggable module is in the communication operation state, an edge of the front jaw outer surface corresponds to an edge of the outer connector, and another edge of the front jaw outer surface corresponds to an edge of the avoidance opening.

10. The pluggable module of claim 3, wherein the first pulling portion comprises a pulling zone configured to allow the user to apply force to move the pluggable module along the pull-out direction.

11. The pluggable module of claim 2, wherein the pulling component comprises a pushing zone, and the pluggable module further comprises:
a latch component physically connected to and housed in the base, wherein the latch component comprises a trigger zone and an unlocking zone, with the unlocking zone positioned closer to the inner connector than the trigger zone thereto;
wherein during a pull-out process of the pluggable module along the pull-out direction, the pushing zone pushes the trigger zone, causing the latch component to move relative to the base along the plug-in direction, and the unlocking zone releases the pluggable module from the electronic device.

12. The pluggable module of claim 11, wherein when the pulling component rotates about the pivot at a pivoting angle greater than 85 degrees, the pushing zone pushes the trigger zone, thereby releasing the pluggable module from the electronic device.

13. The pluggable module of claim 11, wherein when the pluggable module is in a communication operation state, a distance d1 between the unlocking zone and an outer endpoint of the pluggable module along the pull-out direction and a length m1 of the pluggable module along the pull-out direction satisfy the following condition:
0-00.3 ≤ d1/m1 ≤ 0.7.

14. The pluggable module of claim 1, wherein the outer connector comprises a plurality of anti-rotation portions disposed on an outer surface of the outer connector and arranged in a polygonal shape, and the pluggable module further comprises:
a circuit board physically connected to and communicatively connected to the outer connector;
wherein the base comprises a base opening and a plurality of stopper portions, and the outer connector is physically connected to the circuit board through the base opening, with the stopper portions respectively adjacent to the anti-rotation portions;
wherein during a pull-out process of the pluggable module along the pull-out direction, the stopper portions contact and block the anti-rotation portions when the outer connector rotates beyond a rotation threshold, thereby preventing further rotation of the outer connector.

15. The pluggable module of claim 14, wherein a number of the anti-rotation portions is four, and the four anti-rotation portions correspond to four corners of a rectangle.

16. The pluggable module of claim 1, wherein the pluggable module is a Small Form-Factor Pluggable (SFP) module, and the outer connector is an F-type connector.

17. An electronic device, comprising:
a pluggable module having a plug-in direction and a pull-out direction for insertion into and removal from a device opening of the electronic device, the pluggable module comprising:
an outer connector, which is a coaxial connector and comprises a plurality of outer terminals, wherein when the pluggable module is in a communication operation state, the outer connector is exposed on a device outer surface of the electronic device;
an inner connector disposed opposite to the outer connector along the pull-out direction and comprising a plurality of inner terminals communicatively connected to the outer terminals; and
a base, wherein the outer connector and the inner connector are accommodated in the base.

18. The electronic device of claim 17, further comprising:
a fixing frame disposed inside the electronic device and comprising a first latching portion, wherein the base comprises a second latching portion;
wherein when the pluggable module is in the communication operation state, the first latching portion and the second latching portion engage with each other to fix the pluggable module in the fixing frame.

19. The electronic device of claim 18, wherein the fixing frame further comprises an elastic zone, the first latching portion is located at the elastic zone and is an opening, the second latching portion is a protrusion, and the pluggable module further comprises an unlocking zone;
wherein during a pull-out process of the pluggable module along the pull-out direction, the unlocking zone contacts and deforms the elastic zone, thereby disengaging the second latching portion from the first latching portion.

20. The electronic device of claim 17, wherein the pluggable module further comprises:
a pulling component comprising an avoidance opening and a pulling outer surface, wherein the pulling component allows a user to apply force to pull the pluggable module out of the device opening of the electronic device along the pull-out direction; and
a front jaw component made of plastic material and comprising a front jaw outer surface;
wherein when the pluggable module is in the communication operation state, the front jaw component fills a gap in the avoidance opening, and the front jaw outer surface is aligned with the pulling outer surface.
